(19) United States
(12) Patent Application Publication
(10) Pub. No.: US 2025/0174969 A1
(43) Pub. Date: May 29, 2025

(54) APPARATUS AND METHOD FOR LIFTING A SUB-CONDUCTOR BUNDLE

(71) Applicant: QUANTA ASSOCIATES, L.P., Houston, TX (US)

(72) Inventors: Daniel Neil O'Connell, Oliver (CA); Raymond Henry Jodoin, Sherwood Park (CA); David Karl Wabnegger, La Grange, TX (US)

(21) Appl. No.: 18/962,307

(22) Filed: Nov. 27, 2024

Related U.S. Application Data
(60) Provisional application No. 63/659,228, filed on Jun. 12, 2024.
(60) Provisional application No. 63/602,827, filed on Nov. 27, 2023.

(30) Foreign Application Priority Data
Nov. 27, 2023 (CA) 3221460

(51) Int. Cl. H02G 1/04

(52) U.S. Cl. CPC H02G 1/04

(57) ABSTRACT

A horizontal conductor lifter includes a main beam to which an elongate wire holder adapter is connected through a horizontal, stacked bank of insulators and an inclined electrically insulating load transfer element collectively forming an electrically insulating truss to temporarily support the weight of a conductor or sub-conductors in a conductor bundle. The wire holder adapter supports vertically oriented wire holders thereon. A rotation actuator acts between the main beam and a distal end of a boom adapter on a crane or truck boom. In use, the rotation actuator, the stacked bank of insulators and the load transfer element prevent rotation of the wire holders to an off-vertical orientation so that the wire holders are maintained in their operative vertical orientation throughout a maintenance operation.

### FIELD

Embodiments described herein relate to an apparatus mountable on to an end of a truck or crane boom for manipulating energized conductors on a high voltage power line. More particularly, embodiments described herein relate to an apparatus, and a method for using the apparatus for lifting and moving an energized, high voltage sub-conductor bundle, alternatively referred to herein as sub-conductors in a conductor bundle.

### BACKGROUND

At high voltages, for example at 115 kV and up to 500 kV or more, a single phase of a power line may be carried in a conductor bundle consisting of, for example, two, three, or four conductors or more, in order to carry more load and to reduce corona discharge, electric field, and radio interference of carrying a high voltage in a single conductor. Thus, when maintenance is needed on a power line structure such as a pole or a tower carrying the conductor bundle, or, for example, during insulator and/or hardware and/or structure replacement or reconductoring, an existing and energized conductor bundle must be picked, disconnected from the tower or structure, and then moved away from the tower or structure to provide for safe working clearance, the safe working clearance distance increases as the voltage being worked on increases. Due to the weight of the conductor bundle and due to lateral forces acting on the sub-conductors in the conductor bundle, for example, due to wind acting on the sub-conductors in the span during the picking and moving of the conductor bundle away from the tower or structure, it may be difficult to keep the wire holders containing the sub-conductors in their operative vertical orientation at all times. However, it is important to keep the wire holders in their operative vertical orientation during the picking and moving. In their operative vertical orientation, the weight of the sub-conductors is fully supported by rollers or sheaves within the wire holders, and no force is applied to the latching covers on the wire holders when closed over the sub-conductors supported on the rollers or sheaves. In an off-vertical orientation of the wire holders, chances of the sub-conductors pressing against the latching covers is increased. This is not desirable as the sub-conductors pressing against the latching covers may lead to accidental opening of the latching covers and thereby release of the sub-conductors from the wire holders. Since the sub-conductors being held in the wire holders are energized and may be very heavy, release of the sub-conductors from the wire holders may lead to substantial injury or damage to personnel and equipment at the work site. Thus, it is desirable to maintain the wire holders in a vertical orientation during the picking and moving of the conductor bundle.

Conductor bundles are supported at a high elevation on a structure such as a pole or tower. In the prior art, it is known to approach and pick a conductor bundle using a tool using vertically oriented insulators. The tool is mounted onto the end of a truck or crane boom and the boom is manipulated to elevate the tool into position under the conductor bundle to pick and move the conductor bundle. The high elevation of the conductor bundle on the structure, along with right of way constraints, or the presence of adjacent circuits, requires that the crane or truck boom be raised to a high angle, usually between 60° to 80°. On structures where the conductor bundles are supported from the structure one above the other, safe working clearance or limits of approach must be maintained between the crane or truck boom supporting the tool and the energized conductor bundles below. Such a tool works well for the lowermost sub-conductors in the conductor bundle, where the conductor bundles are orientated one above the other, or where the conductor bundles are horizontally spaced apart from one another in a side-by-side horizontal configuration. For the center and top conductor bundle positions having the conductor bundles one above the other, it is difficult if not impossible to pick either of the center or top conductor bundles and maintain a safe working clearance between the crane or truck boom and the energized sub-conductors in the conductor bundle which are located below the conductor bundle being picked.

As seen in FIG. 7 in the accompanying drawings, an incursion by the boom into the safe clearance distance as shown by circle 4c, from a lower conductor bundle may occur if the vertically oriented insulators on the tool on the upper end of a truck or crane boom is used to pick all of the sub-conductors in a conductor bundle located vertically above the lower conductor bundle. What is advantageous so as to avoid incursion into the safe clearance distance of the lower conductor bundle is being able to reach in horizontally or sideways, such as seen in FIG. 8 herein, from outside of any of the safe clearance distances around the conductor bundles suspended from the tower in order to pick the sub-conductors from one of the upper conductor bundles. The horizontal conductor lifter and conductor bundle lifter described and claimed herein, collectively referred to herein as a conductor lifter or horizontal conductor lifter, provides such an advantage.

In the prior art, Applicant is the owner of published patent applications WO/2021/183948 and WO/2021/183906A1, both published 16 Sep. 2021, and entitled, respectively, “Apparatus, System And Method For Lifting And Manipulating Conductors” and “Method and Apparatus for Lifting a Bundle of Sub-Conductors”. Both of these published patent applications are incorporated herein by reference, and disclose the use of insulators arranged in a stack. The stack of insulators is mounted on the end of a truck or crane boom to support wire holders mounted on the apex of the insulator stack. The insulators are arranged in a two-tier stack of parallel insulators approximating a pyramid configuration where a lower tier of the two tiers has a greater number of insulators than the upper tier. The stack of insulators may be rotated between vertical and horizontal.

### SUMMARY

Accordingly, embodiments of a horizontal conductor lifter are described and claimed herein, where the horizontal conductor lifter is mounted on the upper end of a truck or crane boom by means of a boom adapter, and wherein the horizontal conductor lifter includes a main beam which is pivotally coupled to the boom adapter so that an actuator, referred to herein as a rotation actuator, may selectively pivot the main beam between a vertical orientation and an off-vertical orientation. The rotation actuator selectively pivots the main beam relative to the boom adapter during use of the horizontal conductor lifter so as to maintain horizontal a set of insulators mounted on, so as to extend laterally from the main beam. For example, the insulators may be perpendicular to the main beam. The insulators may advantageously be for example, a stacked bank of insulators extending in a horizontal parallel array, between the main beam and a wire holder adapter mounted on the end of the stacked bank of insulators. At least one wire holder may be mounted on the wire holder adapter such that the at least one wire holder is maintained in an operative vertical orientation when the stacked bank of insulators is maintained horizontal by the operation of the rotation actuator.

An elongate, electrically insulating, tensile load transfer element, such as for example an end-to-end coupled linear array of rigid electrical insulators, is coupled, at an upper end, to an upper end of the main beam and, at the opposite, lower end of the tensile load transfer element, to the wire holder adapter mounted on the end of the horizontally oriented stacked bank of insulators. The tensile load transfer element, for example, such as the linear array of insulators, supports, in tension, the weight of a conductor or the weight of sub-conductors in a conductor bundle when supported in the wire holders on the wire holder adapter.

During articulation of the boom, while it is supporting a conductor or sub-conductors in a conductor bundle in the wire holders on the end of the horizontal conductor lifter mounted on the boom adapter at the end of the truck or crane boom, the end of the boom is moved, for example, to provide the above described safe working clearance, such that the angle between the boom adapter and the main beam is adjusted so as to maintain the stacked bank of insulators horizontal. It was recognized by the Applicant that if the horizontal conductor lifter on the end of the truck or crane boom is rigidly affixed to the end of the boom, a change in the angular orientation of the boom relative to horizontal will also and correspondingly change the angular orientation of the stacked bank of insulators away from horizontal. Thus, a wire holder mounted on the wire holder adapter on the horizontal conductor lifter, in which the conductor or sub-conductors of a conductor bundle are being supported, is also tilted so as to be in an off-vertical orientation such that the conductor or sub-conductors in any one wire holder is not centered on their roller or sheave within the wire holder. Disadvantages associated with the off-vertical orientation of the wire holders have already been discussed in the Background. To prevent this and to always maintain the horizontal orientation of the stacked bank of insulators on the horizontal conductor lifter, the rotation actuator cooperates between the boom adapter and the main beam. Again, the rotation actuator rotates the main beam, and simultaneously the stacked bank of insulators, the tensile load transfer element, the wire holder adapter and the wire holder or wire holders relative to the boom adapter so as to maintain the horizontal conductor lifter level during articulation of the boom when temporarily supporting a conductor or sub-conductors in a conductor bundle during relocating the conductor or sub-conductors away from the tower or support structure.

In use, when the conductor is, or the sub-conductors in a conductor bundle are supported in the wire holders, and when, for example, the boom is being translated so as to move the conductor or conductor bundle away from the tower or structure, the weight of the conductor or sub-conductors is taken up by both the load transfer element and the stacked bank of insulators, the former in tension and the latter in compression. Because the wire holder adapter is a rigid structure mounted to the substantially coterminous ends of the load transfer element and the stacked bank of insulators, so as to extend away from the conterminous ends in order to support the wire holders, a bending moment is exerted by the weight of the conductor or sub-conductors on the wire holder adapter. Advantageously the wire holder adapter includes a rigid vertical structure such as a vertical plate so that the lower end of the load transfer element may be mounted at the upper end of the vertical structure and the outer end of the stacked bank of insulators may be mounted to the lower end of the vertical structure. The lower end of the load transfer element may be advantageously pinned or otherwise pivotally mounted to the vertical structure so that the bending moment on the wire holder adapter is not transferred into the load transfer element and the stacked bank of insulators. Thus, the bending moment on the wire holder adapter is resisted by the stacked bank of insulators to thereby resist rotation of the wire holder adapter away from supporting the wire holders mounted thereon in their operative vertical orientation, and so as to maintain the vertical orientation of the wire holders during use.

Further advantageously, the stacked bank of insulators forms a pyramid where, within two tiers of parallel insulators, the tier closest to the main beam has more insulators within the tier than number of insulators in the tier adjacent to the wire holder adapter, thereby forming a pyramidal shape having an apex abutting the wire holder adapter. In the embodiment where the wire holder adapter includes the vertical structure such as the vertical plate, the apex of the stacked bank of insulators is centered on the vertical structure so as to align, or is otherwise aligned laterally with a center of mass of the conductor or sub-conductors in a conductor bundle when held in the wire holders. Applicant postulates that lateral, i.e., horizontal, alignment of the apex of the stacked bank of insulators with the approximate center of mass of the weight load being carried in the wire holder or wire holders tends to evenly distribute the pressure on, and thereby the compression load in, all of the insulators in the stacked bank of insulators.

A corresponding method of use includes actuating the rotation actuator while articulating the boom and moving the conductor or conductor bundle away from its original position to a new temporary position, spaced away from the original position, while maintaining the horizontal conductor lifter in its operative horizontal orientation with the wire holders vertical during and after the move.

### BRIEF DESCRIPTION OF THE DRAWINGS

FIG. 1 is a side elevation view of one embodiment of a horizontal conductor lifter described herein, mounted on a boom adapter with a rotation actuator of the horizontal conductor lifter retracted;

FIG. 1A is the view of FIG. 1 showing the horizontal conductor lifter and the boom adapter mounted on the upper end of a crane or truck boom;

FIG. 2 is the horizontal conductor lifter of FIG. 1 with the rotation actuator extended;

FIG. 3 is the horizontal conductor lifter of FIG. 2 in rear perspective view;

FIG. 4 is the horizontal conductor lifter of FIG. 1 in front perspective view;

FIG. 5A is, in rear perspective view, a wire holder adapter of the horizontal conductor lifter of FIG. 1;

FIG. 5B is, in front perspective view, the wire holder adapter of FIG. 5A;

FIG. 6 is, an example of a double circuit 500 kV suspension tower with the conductor bundles located one above the other and the safe working clearance shown by the circles around the conductor bundles and with the safe working clearance being outside the circles;

FIG. 7 is the view of FIG. 6 showing a prior art tool having a vertical insulator stack to lift the sub-conductors of the middle or center conductor bundle on the right-side circuit on the tower, and illustrating a violation of safe working clearance around the lower conductor bundle on the right-side circuit;

FIG. 8 is the view of FIG. 6 showing the horizontal conductor lifter of FIG. 1A lifting the middle conductor bundle on the left side circuit on the tower, and illustrating the maintaining of a safe working clearance around the lower conductor bundle on the left side circuit;

FIG. 9 is a close up and detailed view of the wire holder adapter of FIG. 5B, showing a four-bundle wire holder mounted on the wire holder adapter;

FIG. 10 is, in rear perspective view, the insulator stack, the wire holder adapter, and four bundle wire holder of FIG. 1;

FIG. 11A is the insulator base of the horizontal conductor lifter of FIG. 1 in front perspective view;

FIG. 11B is the insulator base of FIG. 11A in rear perspective view;

FIG. 12 is the insulator adapter plate of the horizontal conductor lifter of FIG. 10;

FIG. 13A is a front perspective view of the main beam of the horizontal conductor lifter of FIG. 1;

FIG. 13B is a rear perspective view of the main beam of the horizontal conductor lifter of FIG. 1;

FIG. 14 is a perspective view of a crane-to-actuator scissor link of the rotation actuator of the horizontal conductor lifter of FIG. 1;

FIG. 15 is a perspective view of the actuator-to-main beam scissor link of the rotation actuator of the horizontal conductor lifter of FIG. 1;

FIG. 16A is a front perspective view of the boom adapter of FIG. 1;

FIG. 16B is a rear perspective view of the boom adapter of FIG. 1;

FIG. 17 is a perspective view of a hydraulic cylinder of the rotation actuator of horizontal conductor lifter of FIG. 1;

FIG. 18 is a perspective view of a second embodiment of the horizontal conductor lifter of FIG. 1 showing a second form of rotation actuator;

FIG. 19 is the boom adapter and installation of the rotation actuator of FIG. 18 in side elevation view;

FIG. 19A is the embodiment of FIG. 19 showing the trunnion block of the rotation actuator mounted into the boom adapter;

FIG. 20A is, in side elevation view, the horizontal conductor lifter of FIG. 18 with the rotation actuator extended;

FIG. 20B is the plan view of FIG. 20A with the rotation actuator extended;

FIG. 20C is, in side elevation view, the horizontal conductor lifter of FIG. 18 with the rotation actuator retracted;

FIG. 20D is, in plan view, the horizontal conductor lifter of FIG. 20C;

FIG. 21A is a section view along line A-A in FIG. 20B; and

FIG. 21B is a section view along line A-A in FIG. 20D.

### DETAILED DESCRIPTION

Embodiments described herein relate to an apparatus, referred to herein as a horizontal conductor lifter, for safely lifting and moving live, a high-voltage conductor or conductor bundle, such as a 500 kV four sub-conductors in a conductor bundle, supported on a tower or structure, above ground, during a maintenance operation. The horizontal conductor lifter is configured to be mountable to a distal end of a crane or truck boom during use and is configured to maintain a vertical orientation of its associated wire holders, independent of the angular orientation of the boom, at all times during the lifting and moving, and during the maintenance operation. Problems such as unintended release of conductors from the wire holders due to tilting of the wire holders, are thus avoided. The horizontal conductor lifter enables the supporting and manipulation of the conductor or sub-conductors in a conductor bundle while maintaining safe working clearances from energized conductors or conductor bundles below, above, or adjacent the crane or truck boom.

Although the horizontal conductor lifter has been described and illustrated herein as used with a 500 kV four sub-conductors in a conductor bundle, it is to be understood that phase conductors, or other conductor bundles of one, two, three, four, or more sub-conductors of other voltage ratings, lower or higher, may be lifted and moved using the horizontal conductor lifter described herein.

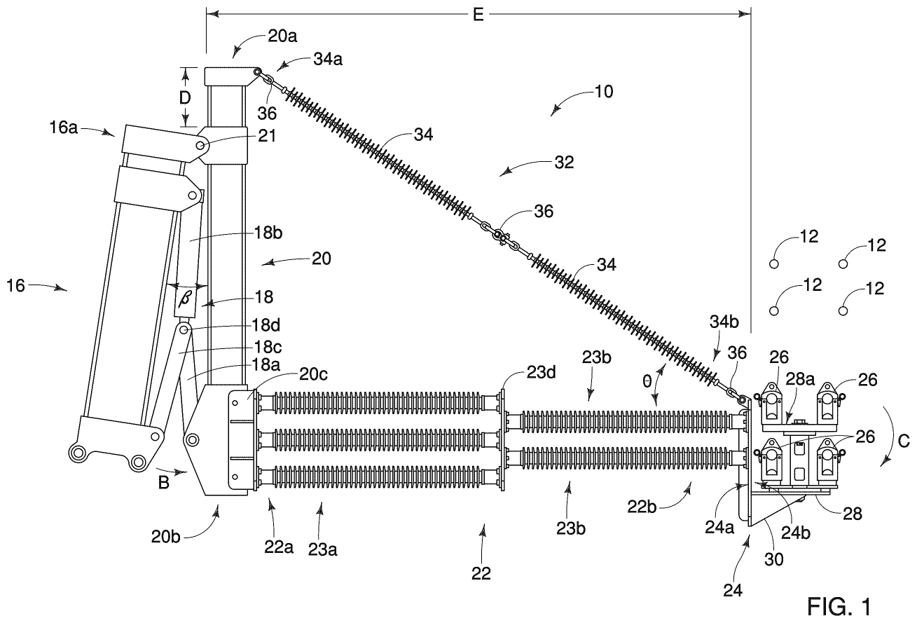

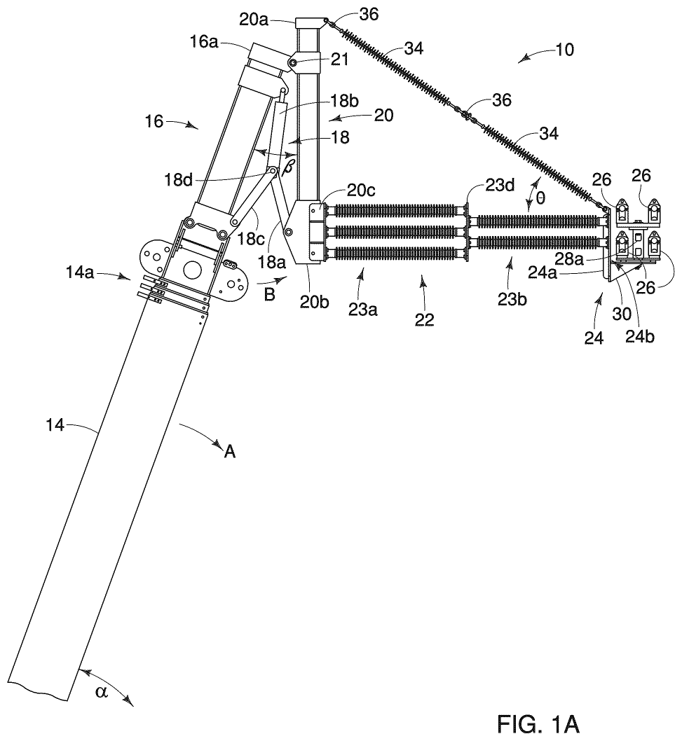

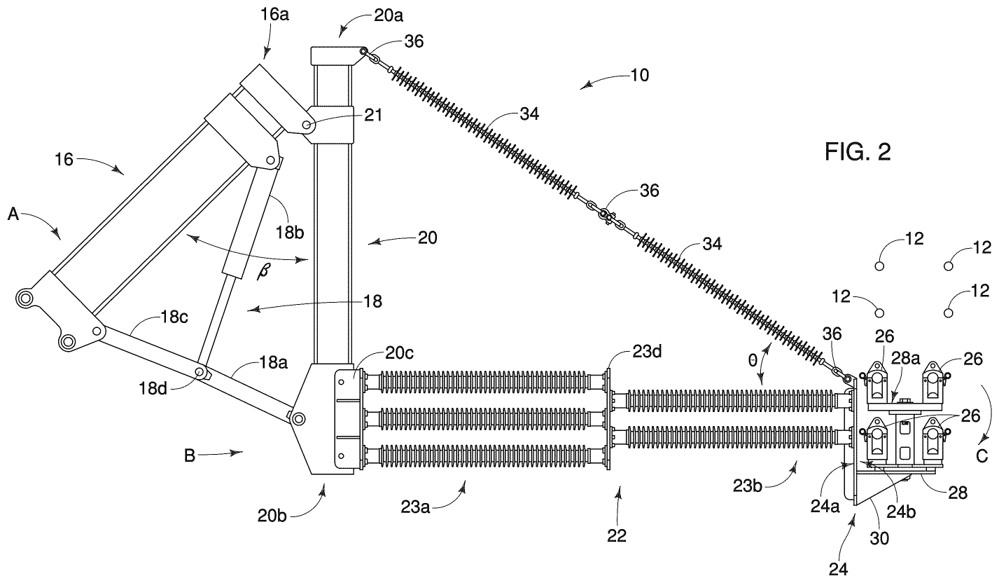

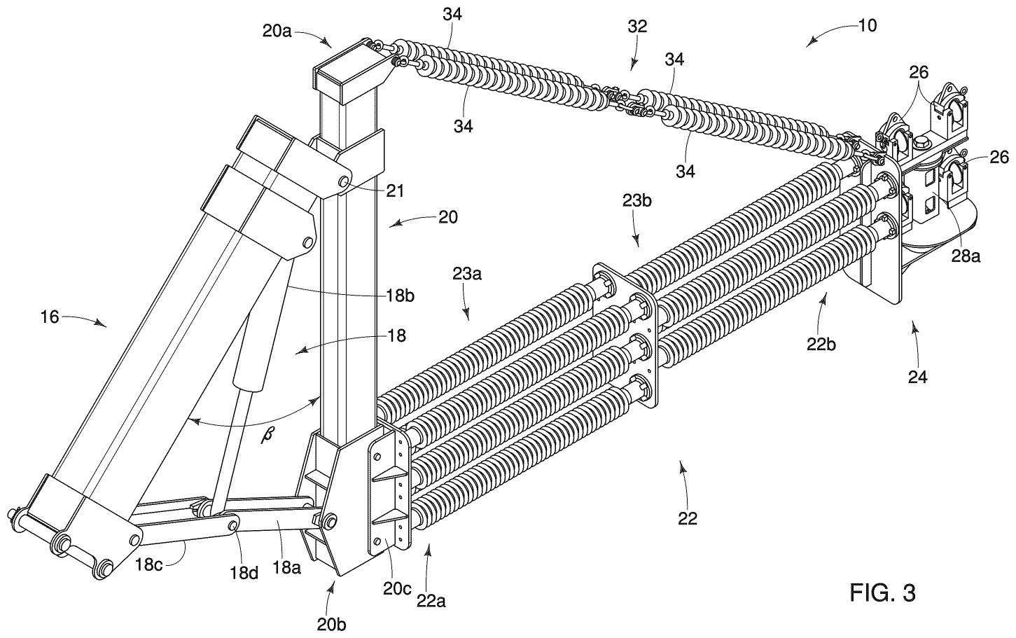

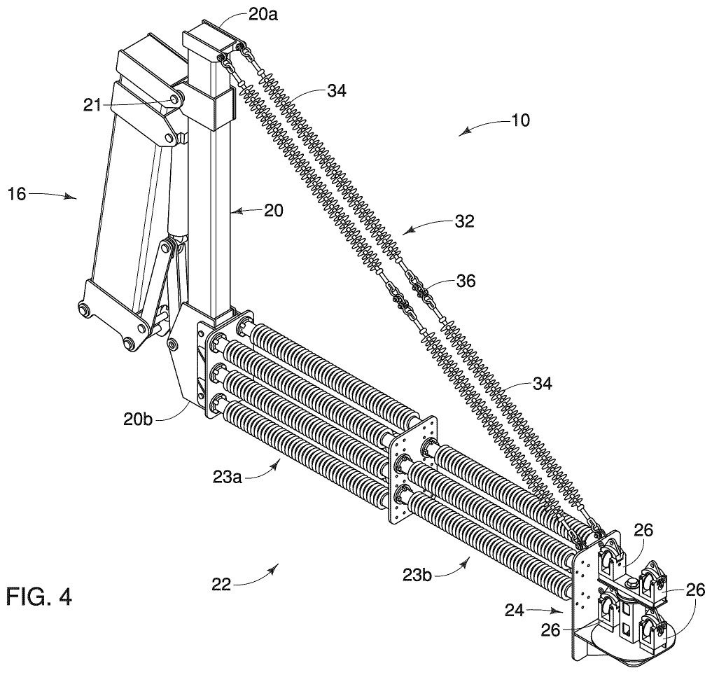

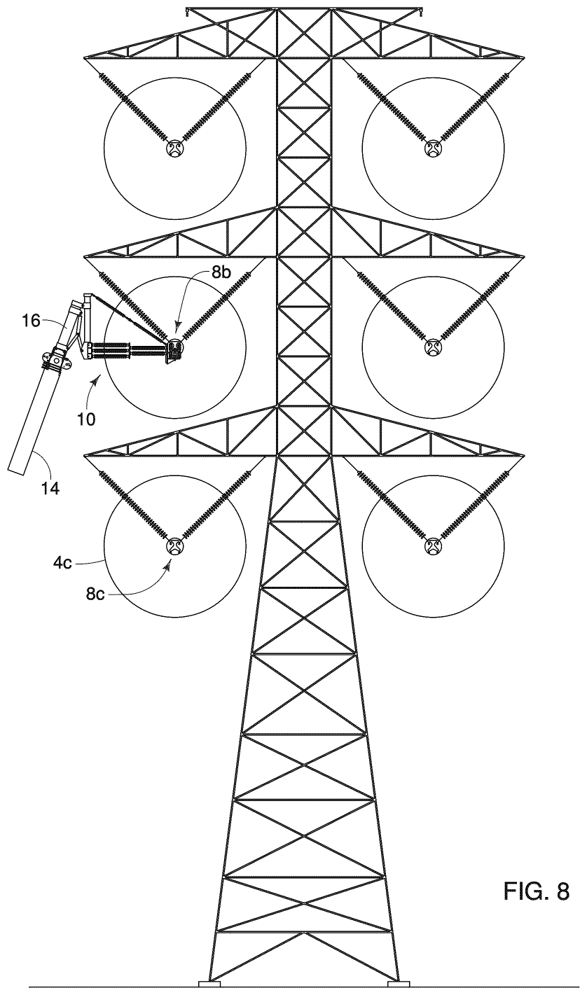

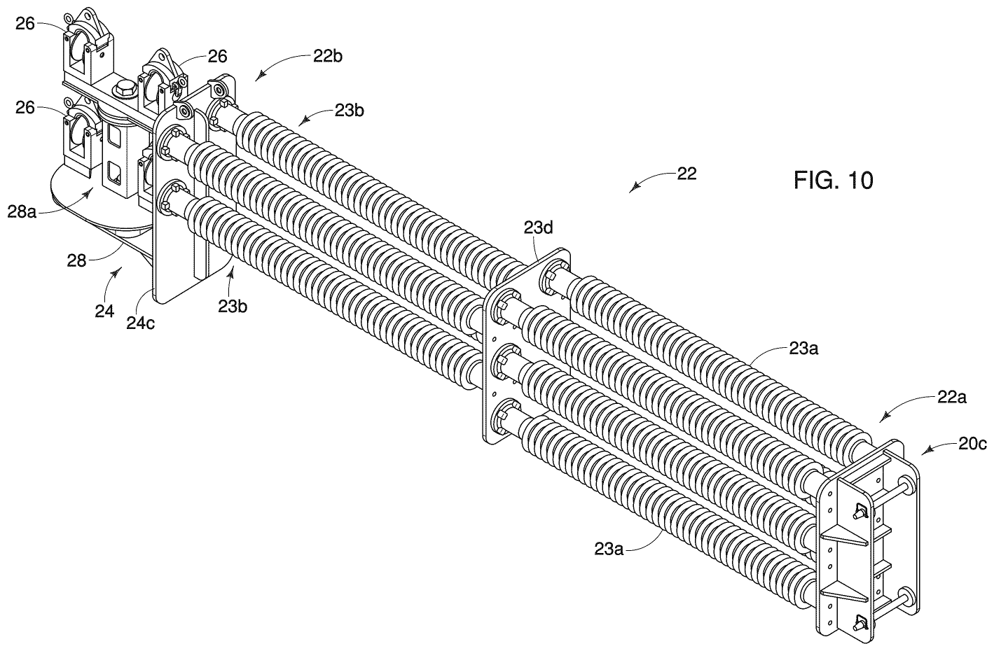

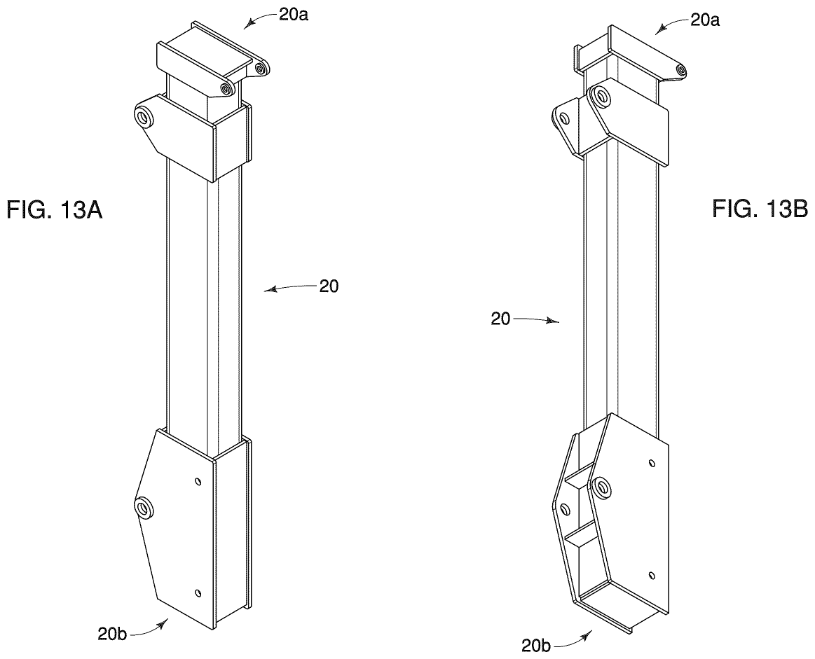

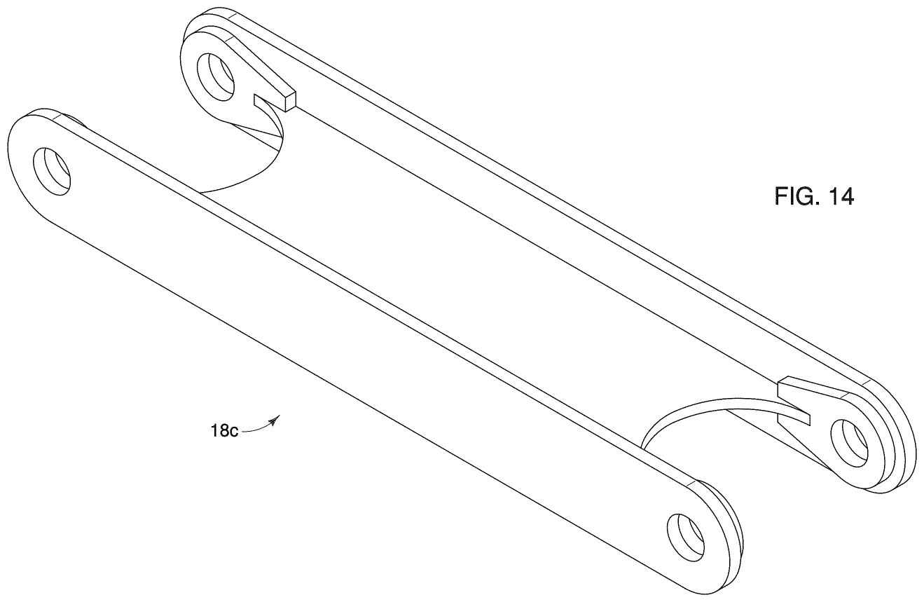

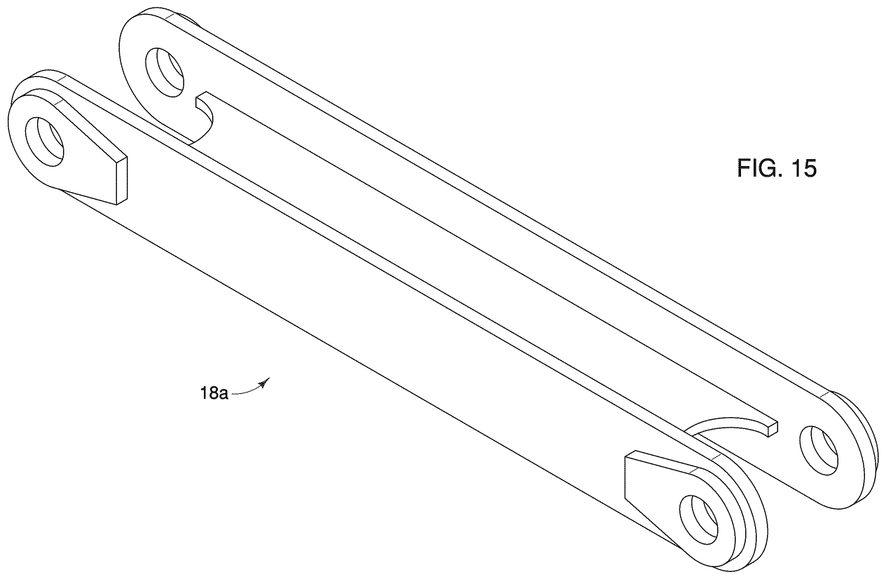

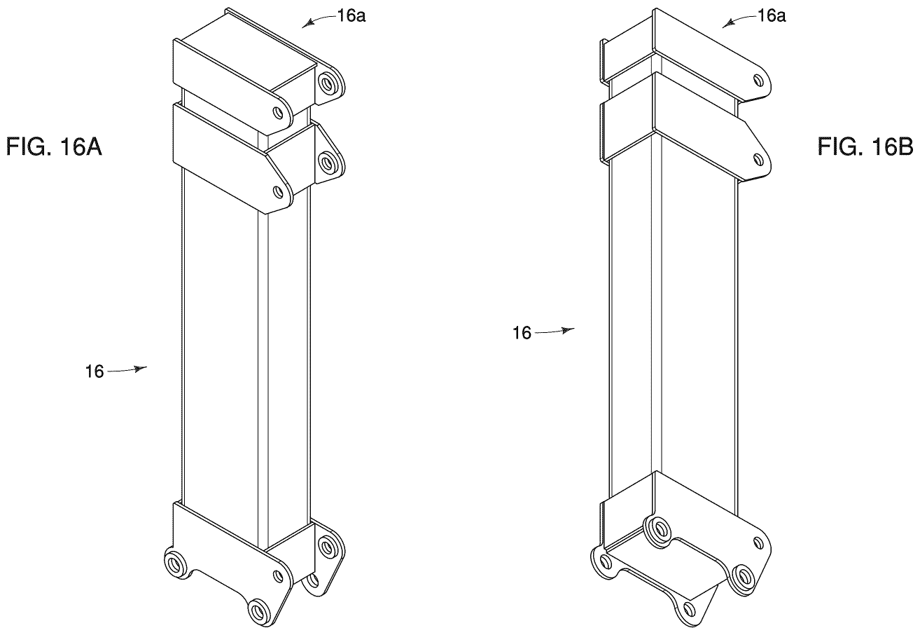

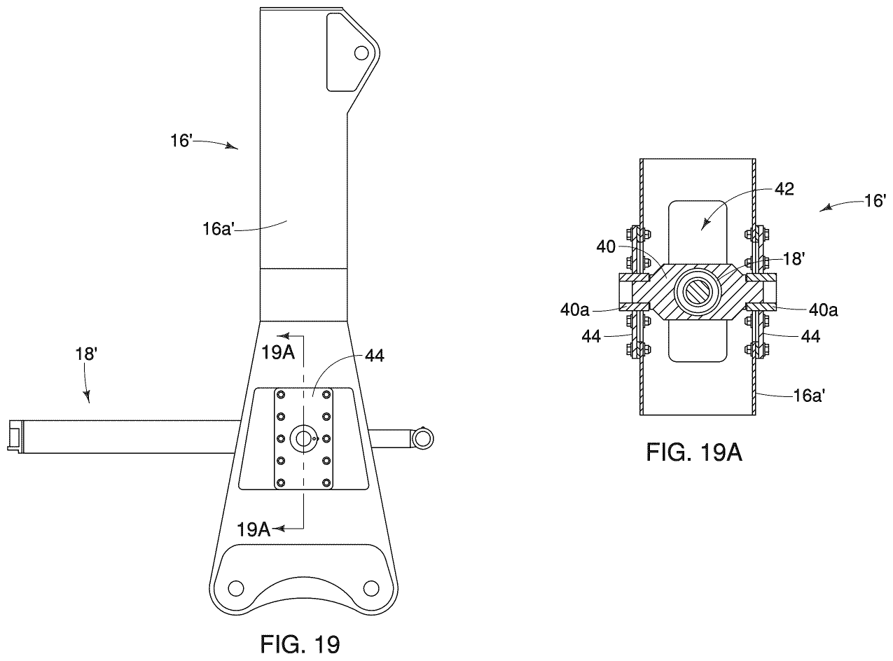

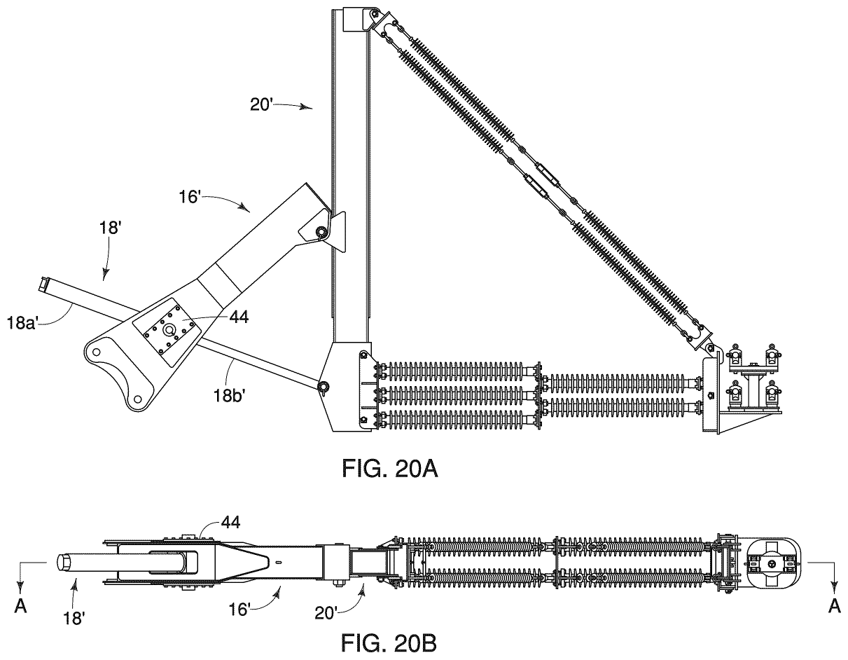

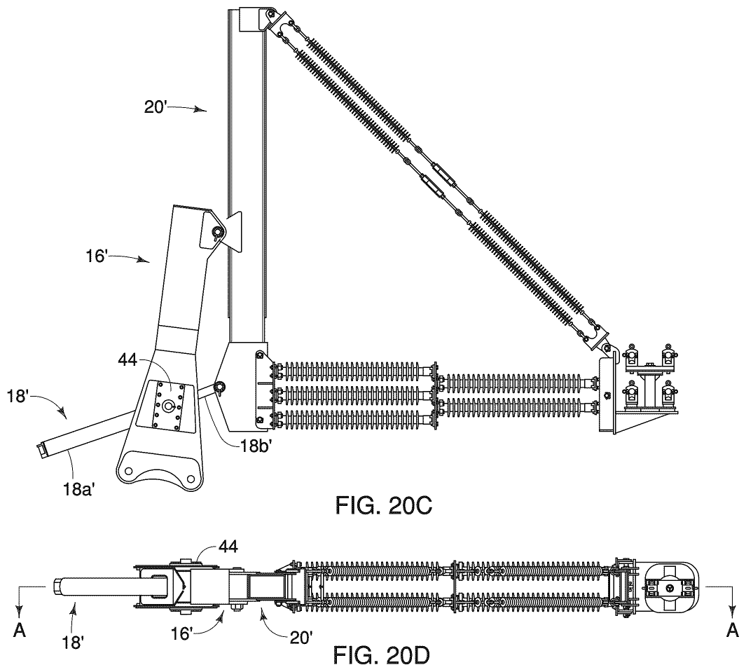

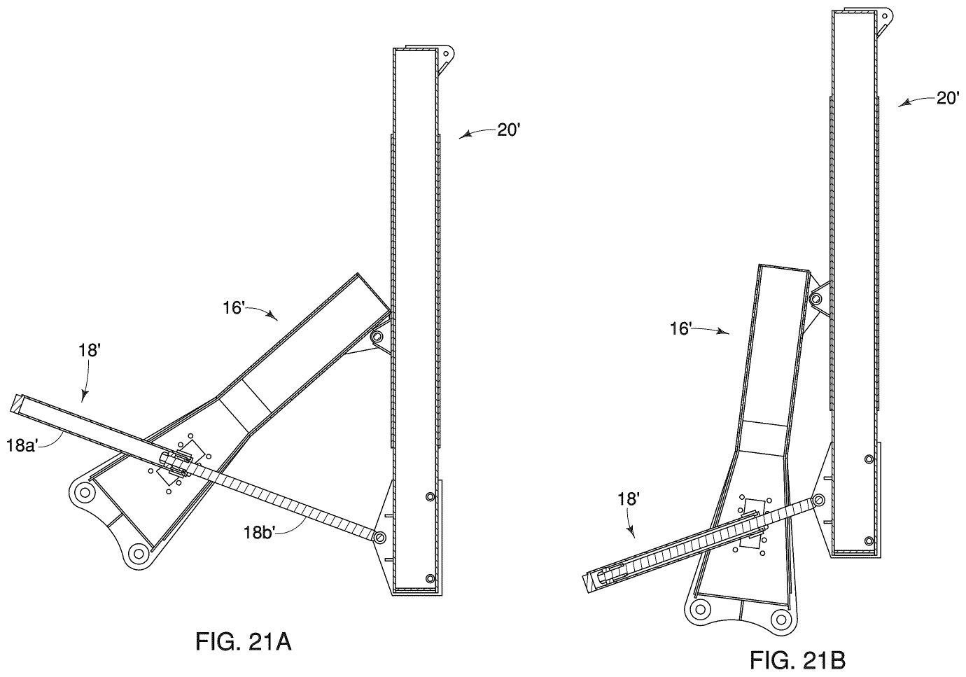

FIGS. 1 to 4 illustrate one example of a horizontal conductor lifter such as described and claimed herein. The horizontal conductor lifter 10 is used for supporting, lifting, and moving sub-conductors 12 in a conductor bundle as shown in FIG. 1 and FIG. 2, either energized or de-energized, in a four sub-conductor, conductor bundle laterally away from or laterally towards a tower such as shown by way of example in FIG. 8 supporting the conductor bundle above ground. Horizontal conductor lifter 10 is mounted to a distal end 14a of a crane or truck boom 14 using a boom adapter 16 such as better seen in FIG. 16A and FIG. 16B. A main beam 20 such as better seen in FIG. 13A and FIG. 13B is pivotally coupled to the boom adapter 16. A stack of insulators 22 is mounted to the lower end of the main beam 20, preferably so as to extend away perpendicularly from the main beam 20 although off-perpendicular orientation would also work if constrained to a small inclination or declination from perpendicular. A rotation actuator 18, such as the combinations, illustrated by way of example, of hydraulic cylinder 18b with scissor linkage members 18a and 18c shown in FIG. 1, and hydraulic cylinder 18′ with trunnion block 40 shown in FIG. 19A., selectively actuates rotation of main beam 20 relative to boom adapter 16 so as to maintain the stack of insulators 22 level, wherein, as used herein, reference to level is intended to mean substantially horizontal within the limits of small inclination or declination from horizontal. Boom adapter 16 is better seen in FIG. 16A and FIG. 16B. Main beam 20 is better seen in FIG. 13A and FIG. 13B. The stacked bank of insulators 22 is better seen for example in FIG. 10.

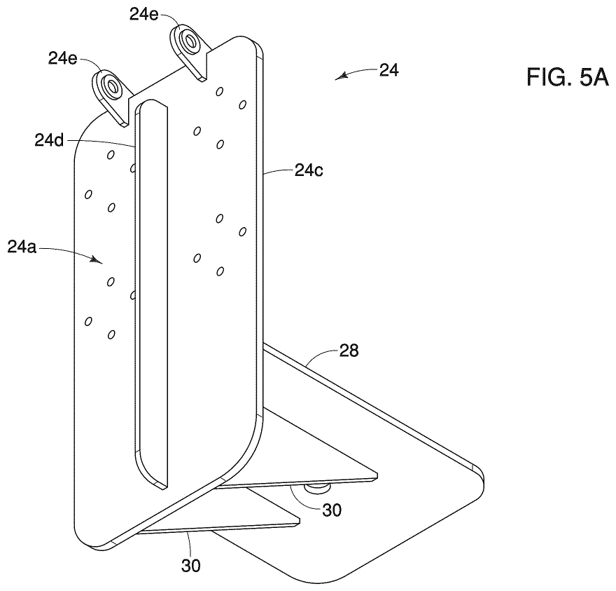

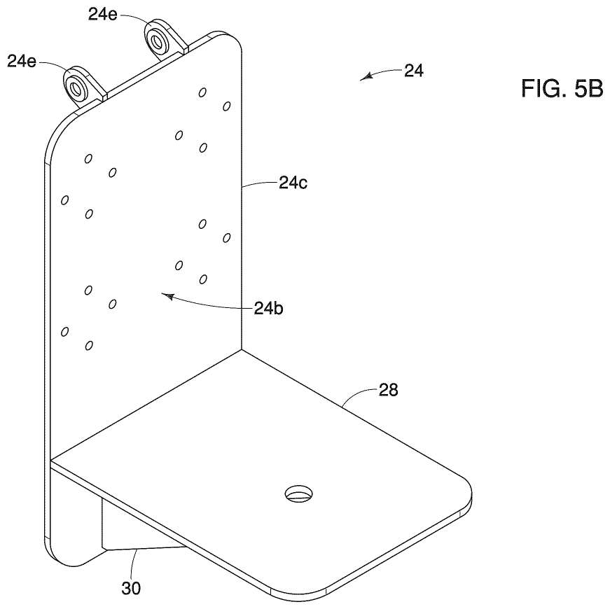

Main beam 20 is pivotally coupled to the upper end of boom adapter 16 for selective pivotal rotation in a substantially vertical plane of main beam 20 relative to boom adapter 16 about pin 21. Pin 21 provides for unconstrained rotation of the main beam 20. The stack of insulators 22 supports the wire holder adapter 24, shown by way of example in FIG. 5A and FIG. 5B, spaced horizontally away from the main beam 20 by the safe clearance distance corresponding to the voltage carried in the conductor or sub-conductors in a conductor bundle carried in the wire holders 26 mounted on wire holder adapter 24. The stacked bank of insulators 22 are shown in better detail in FIG. 10 as a stacked bank of rigid electrical insulators 22 extending in a horizontal parallel array with a first bank or tier of insulators having a greater number of insulators than a second bank or tier of insulators so as to form a truncated pyramid of insulators 22. The stack of insulators 22 extends between, so as to be coupled to, the lower end of the main beam 20 at the base end of the first bank of insulators and the wire holder adapter 24 at the remote end of the second bank of insulators, wherein the remote end of the second bank of insulators coincides with the apex of the stack of insulators 22.

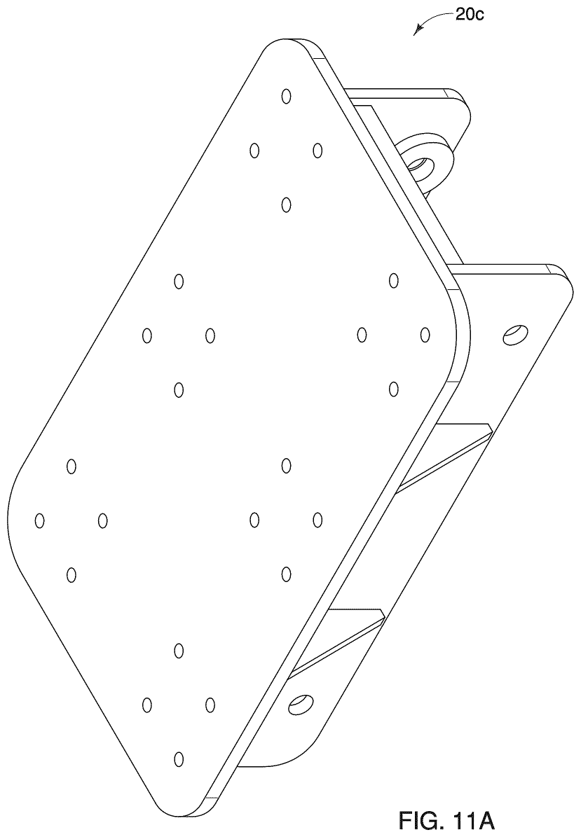

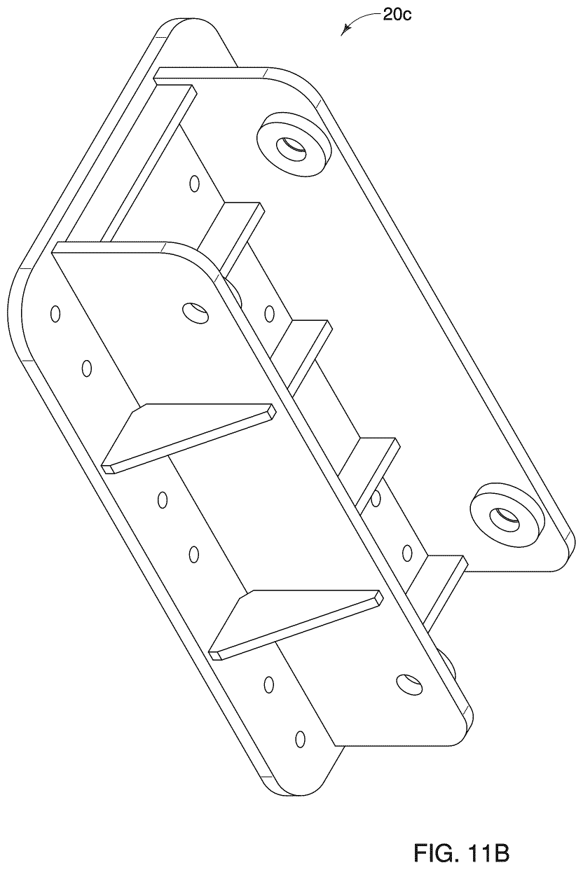

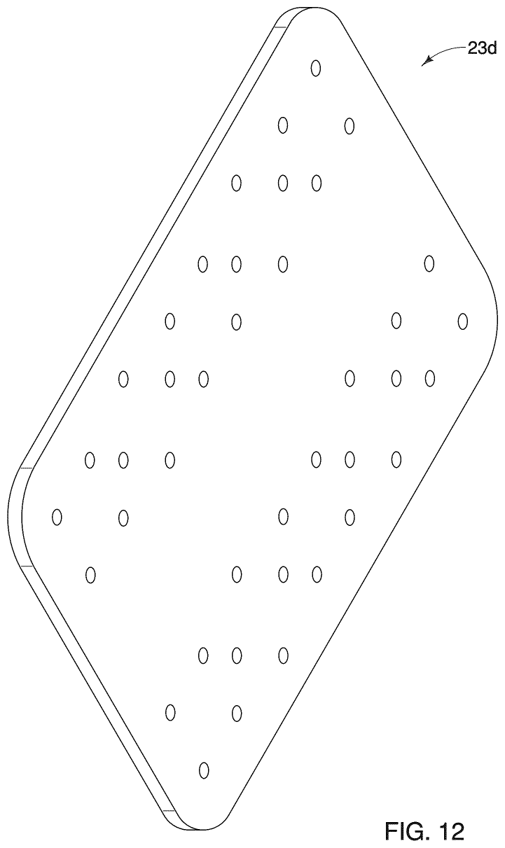

In one embodiment, the stacked bank of insulators 22 includes a first number of insulators, such as six insulators, in the first bank or base bank 23a, and a second number of insulators, such as four insulators, in the second bank or distal bank 23b. In the preferred embodiments, the number of insulators in the base bank 23a is greater than the number of insulators in the distal bank 23b. The stacked bank of insulators 22 collectively has opposite ends 22a and 22b. End 22a is at the base end of base bank 23a and is coupled to lower end 20b of the main beam 20 using insulator base mount 20c as shown in FIG. 11A and FIG. 11B. The other end of base bank 23a is coupled to an insulator adapter plate 23d, better seen in FIG. 12, connecting base bank 23a to distal bank 23b. The distal bank 23b is mounted between the insulator adapter plate 23d and the wire holder adapter 24. End 22b of the stacked bank of insulators is the apex, at the remote end of the distal bank 23b and is mounted to a first side 24a of the vertical plate 24c of wire holder adapter 24, better seen in FIGS. 5A and 5B, where it is understood that the configuration of wire holder adapter 24 is by way of example as other configurations would also work.

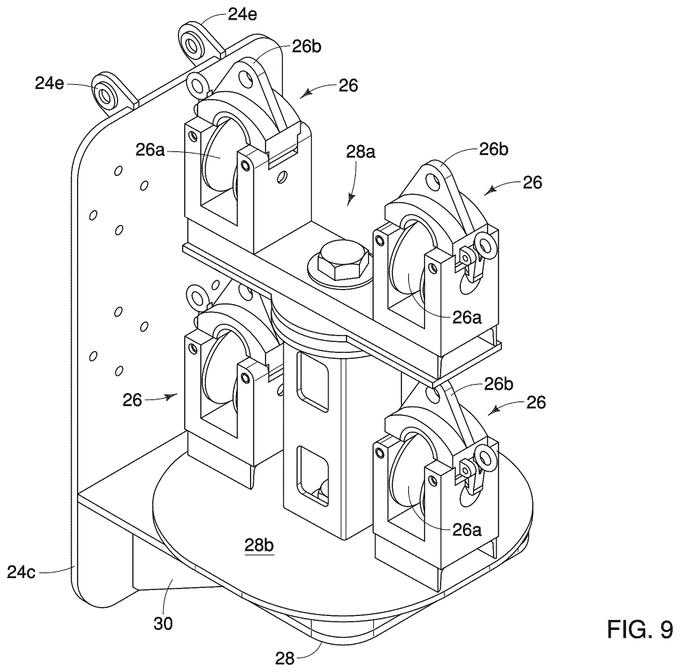

A plurality of wire holders 26 are mounted on wire holder adapter 24 as shown by way of example in FIG. 9, which shows four wire holders 26 mounted on a four sub-conductor bundle lifter 28a. Bundle lifter 28a is mounted on horizontally cantilevered plate 28, better seen in FIG. 5A and FIG. 5B, located on the second side 24b, opposite first side 24a, of the wire holder adapter 24. The wire holders 26 support the sub-conductors 12 in the conductor bundle during use of the horizontal conductor lifter. In the illustrated embodiment, not intended to be limiting, four wire holders 26 are mounted to the second side 24b of the wire holder adapter 24. In use, each of the four sub-conductors 12 of the conductor bundle is supported in its corresponding wire holder 26, with the sub-conductor 12 resting on sheave 26a. Each sub-conductor 12 is secured under a latched cover 26b, better seen in FIG. 9. The support structure supporting the four wire holders 26 may be, without intending to be limiting, a bundle lifter 28a, such as taught in Applicant's afore-mentioned Bundle Lifter Application, PCT application number WO 2021/183906A1.

The wire holder adapter 24 is mounted to the stacked bank of insulators 22 so as to maintain plate 24c in a vertical orientation. A horizontal support plate 28 is rigidly mounted to or formed so as to be integral with plate 24c. Horizontal support plate 28 may be cantilevered or under-supported as illustrated so as to extend orthogonally from plate 24c. In a preferred embodiment, and as illustrated, the wire holders 26 are mounted on the upper surface of support plate 28. Braces 30 brace support plate 28 from underneath, extending between the lower surface of horizontal support plate 28 and the lower end of vertical plate 24c. In the embodiment of FIG. 5A and FIG. 5B, a stiffening rib 24d is mounted by way of example vertically along the back of plate 24c.

The wire holders 26 are mounted in their operative vertical orientation. For example, wire holders 26 may be mounted on a support structure 28a (best seen by way of example in FIG. 9) on horizontal support plate 28. Support structure 28a may for example be mounted on a swivel plate 28b which allows the orientation of sheaves 26a to be adjusted to align with the sub-conductors in a conductor bundle in instances where the boom, and hence the stack of insulators 22 and the wire holder adapter 24 cannot, for a variety of possible reasons as would be known to one skilled in the art including terrain, right-of-way restrictions, etc., be brought to perpendicular to the sub-conductors in a conductor bundle. In the illustrated example, and as mentioned above, the support structure 28a is one configuration for supporting four sub-conductors in a conductor bundle. Other structural configurations of support structure 28a would be provided for other conductor bundles, for example two or three sub-conductors in a conductor bundle.

The load transfer element 32 in the illustrated example, not intended to be limiting, connected diagonally between the main beam 20 at the upper end of load transfer element 32 and the wire holder adapter 24 at the lower end of load transfer element 32, includes rigid electrically insulating insulators 34 arranged as an end-to-end coupled linear array of two parallel pairs of rigid electrical insulators (also referred to herein merely as a linear array of insulators) including two pairs of insulators 34. The linear array of insulators has, collectively, opposite upper, and lower ends 34a and 34b respectively. The upper end 34a is coupled to an upper end 20a of the main beam 20. The lower end 34b is coupled to the upper end of the first side 24a of vertical plate 24c on wire holder adapter 24, for example by a pinned mounting to top eyes 24e. The pinned mounting of lower end 34b of insulators 34 to eyes 24e provides a pivoting hinged coupling which does not impart a bending moment on vertical plate 24c. Stiffening rib 24d is linear and mounted to side 24a so as to run along the vertical centroid of vertical plate 24c.

The stacked bank of insulators 22 and the linear array of insulators 32 form an electrically insulated truss so that a loading on the wire holder adapter 24 due to the weight of a conductor or the sub-conductors 12 in a conductor bundle on the wire holders 26 is taken up by the truss and transferred to the main beam 20. Due to the loading on the wire holder adapter 24 the linear array of insulators 32 are in tension and the stacked bank of insulators 22 are in compression. The length and electrically resistive rating of the insulators in the stacked bank of insulators 22 provide the electrical isolation for the safe clearance distance between the energized sub-conductors 12 in the wire holders 26 and the main beam 20. As will be understood by one skilled in the art, the length of the insulators and/or the number of insulators in the both the stacked bank of insulators 22 and the linear array of insulators 32 used to provide the electrical isolation will vary depending on the voltage carried by the conductor bundle. The presently illustrated embodiment is an example intended to lift four sub-conductors in a conductor bundle carrying 500 kV. With corresponding adjustment to the length of, and insulative value of, the insulators in the stacked bank of insulators 22 and the corresponding linear array of insulators 32 in the diagonal load transfer element, the conductor bundle being supported, lifted, and moved may carry voltages other than 500 kV.

In the illustrated embodiment, not intended to be limiting, the insulators of the stacked bank of insulators 22 may be 80-inch, 230 kV insulators, and the insulators 34 of the linear array of insulators 32 may be 230 kV dead end insulators.

As illustrated, and without intending to be limiting, the linear array of insulators 32 includes two insulators 34 coupled end-to-end to each other by shackles 36. Shackles 36 may also be used to couple the ends of linear array of insulators 32 to the main beam 20 and the wire holder adapter 24.

The boom adapter 16 is adapted to be mounted onto the distal end 14a of the crane or truck boom 14. The main beam 20 is coupled to the boom adapter 16 by pinned coupling 21 and rotation actuator 18. As noted above, in one embodiment, the rotation actuator 18 may include scissor linkages 18a, 18c, and a hydraulic cylinder 18b, and in another embodiment may included a hydraulic actuator 18′ and a trunnion block 40, the latter described below by way of further example.

The scissor linkage members, seen by way of example in FIGS. 1-3, Are individually illustrated in FIGS. 14 and 15. Linkage member 18a, best seen in FIG. 15, is pivotally coupled between the main beam 20 and the lower end of hydraulic cylinder 18b. Linkage member 18c, best seen in FIG. 14, is pivotally coupled between the lower end of the hydraulic cylinder 18b and the boom adapter 16. The hydraulic cylinder 18b is mounted to, so as to extend between, the upper end 16a of boom adapter 16 and the pivotal coupling, such as provided by a hinge or pin 18d between the overlapping ends of linkage members 18a and 18c.

The rotation actuator 18 is actuated to maintain the vertical orientation of the wire holders 26 on the wire holder adapter 24 when the crane or truck boom 14 is re-oriented so as to move the end 14a of the boom 14 up or down during use of the horizontal conductor lifter 10 for supporting, lifting and moving the conductor bundle. Changes in orientation of the crane or truck boom 14 with respect to the horizontal is shown by way of example as direction A in FIG. 1A and FIG. 2. In FIG. 1A, boom 14 is near to vertical and consequently rotation actuator 18 is in its fully retracted position to maintain horizontal the stack of insulators 22. In FIG. 2 boom 14 is lowered to approximately a 45-degree angle and consequently rotation actuator 18 is in its fully extended position so as to reduce the included angles alpha (shown in FIG. 1A between boom 14 and the horizontal) and beta (shown in FIGS. 1, 1A and 2 between boom adapter 16 and main beam 20) to maintain horizontal the stack of insulators 22. In the illustrated example, not intended to be limiting, angle beta has an approximate angular range of between 8 degrees in FIG. 1A and 45 degrees in FIG. 2.

As described above, the upper end 20a of the main beam 20 is pivotally coupled to the boom adapter 16 for rotation of the main beam 20 in a vertical plane relative to the boom adapter 16. The vertical plane, which in FIGS. 1 and 2 is the plane containing the page of the illustration, and includes in the illustrated example the boom adapter 16, main beam 20, and rotation actuator 18. The stacked bank of insulators 22 and linear array of insulators 32 are either included in, or parallel to the vertical plane. Actuation of the rotation actuator 18 selectively pivots or rotates the main beam 20 outwardly from boom adapter 16 in direction B, as seen in FIG. 1 and FIG. 2, to thereby increase angle beta. By way of example, hydraulic cylinder 18b may have a 44-inch length when retracted, such as seen in FIG. 1, and a 73-inch length when extended such as seen in FIG. 2, for providing angle beta an approximately 37-degree angular range of motion. Thus, within these limits in the illustrated example, the stacked bank of insulators 22 may be maintained horizontal by an operator remotely actuating the rotation actuator 18 while boom 14 is rotated to increase or decrease angle alpha. The operator of rotation actuator 18 may be for example remotely located in a raised bucket (not shown) near to the conductor bundle being moved.

In the illustrated embodiment, again not intending to be limiting, upper end 20a of main beam 20 is offset vertically upwards by a distance D from the upper end 16a of boom adapter 16. For a preset length for boom adapter 16, the vertical offset distance D will be set by the length of main beam 20, the length of stacked bank of insulators 22 and the desired included angle theta (the angle between the longitudinal axis of linear array of insulators 32 and the horizontal). Optimizing the strength of the truss formed by the stacked bank of insulators 22 on main beam 20 will provide a desired range of angles for angle theta. The desired angle theta, for particular lengths of the stacked bank of insulators 22, may dictate a longer or shorter main beam 20. Because of the typically fixed length of boom adapter 16, the use of vertical offset distance D, so that the upper end of main beam 20 extends upwardly from the upper end 16a of boom adapter 16, allows for optimizing included angle theta for the particular lengths and numbers of insulators in the stacked bank of insulators 22 and in the linear array of insulators 32 required to provide the desired safe separation clearance distance E between the wire holders 26 and their sub-conductors 12, and the main beam 20.

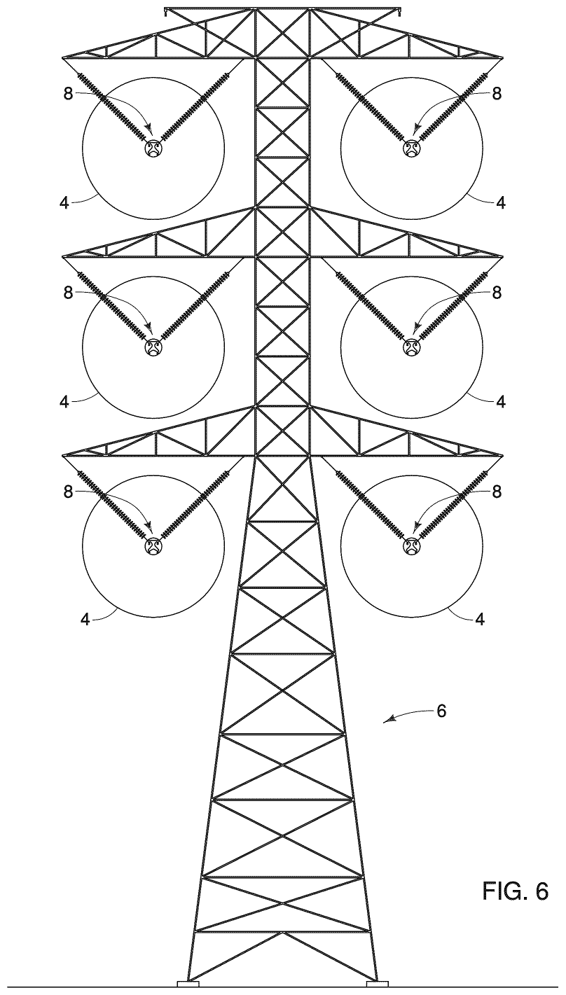

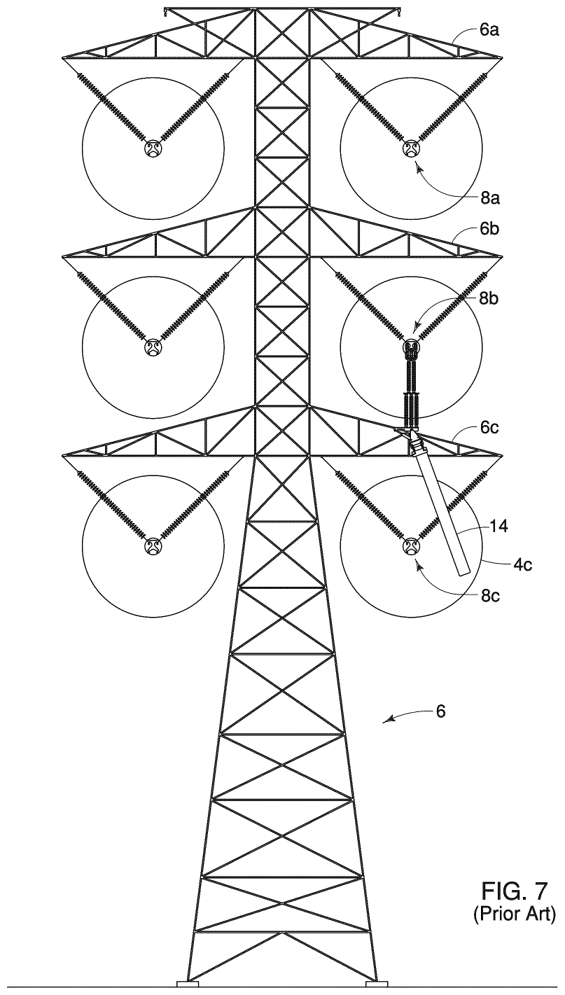

As shown in FIG. 6, FIG. 7, and FIG. 8 the use of the horizontal conductor lifter 10 allows supporting, lifting, and moving a conductor bundle while maintaining a safe working clearance distance that must be maintained, diagrammatically illustrated as circles 4, from the energized conductor bundles adjacent the crane or truck boom 14. Safe working clearance distances mean that neither linemen nor electrically conductive equipment are permitted to infringe within the safe clearance distances indicated diagrammatically by way of example by circles 4. FIG. 6 illustrates an example of a 500 kV double circuit tower 6 with conductor bundles 8 orientated one above the other. FIG. 7 shows the use of a conventional, vertically oriented conductor lifter being used to vertically support, lift, and move the center conductor bundle 8b, being in the illustrated example the conductor bundle supported on the right side of the tower 6 under the center tower arm 6b of tower 6 with tower arms 6a, 6b and 6c supporting conductor bundles 8a, 8b, and 8c, respectively. It can be seen that the crane or truck boom 14 infringes the safe working clearance distance as shown by boom 14 crossing into circle 4c, corresponding to the right-side conductor bundle 8c, and thus violates the safe working clearance distance from the right-side bottom conductor bundle 8c below. FIG. 8 shows the use of the presently described horizontal conductor lifter 10 being used to support, lift, and move the left side center conductor bundle 8b. It can be seen that the crane or truck boom 14 does not violate the safe working clearance distance from the left side bottom conductor bundle 8c below as indicated by non-incursion of boom 14 into the left side circle 4c.

As described in the Background, above, maintaining vertical orientation of the wire holders during a maintenance operation is desirable. Loading on the wire holder adapter due to the weight of the sub-conductors in a conductor bundle on the wire holders 26 produces a bending moment which tends to cause rotation of the wire holder adapter 24 in direction C, seen in FIGS. 1 and 2. If the bending moment is not offset, this may lead to a downward flexing of horizontal plate 28 causing an off-vertical or tilted orientation of the wire holders 26. To prevent this, the bending moment caused by the torsional loading on the horizontal plate 28, which if not resisted, would cause rotation in direction C, is transferred to the main beam 20 by brace 30 which transfers the load to vertical plate 24c, and by both the stacked bank of insulators 22, which is in compression, and a load transfer element such as the linear array of insulators 32, which is in tension.

Transfer of both a tensile and compressive load to main beam 20 ensures that the wire holder adapter 24 and wire holders 26 are held in their vertical orientation by the actuation of the rotation actuator 18 to maintain the vertical orientation of the wire holders throughout re-orientation of the boom 14 no matter whether the boom is raised or lowered. Also, it further enables the supporting and manipulation of the conductor bundle while maintaining safe working clearances from energized conductor bundles adjacent to the crane or truck boom.

In one embodiment, not intended to be limiting, the function of maintaining the wire holders vertical by maintaining the horizontal conductor lifter and its stack of insulators horizontal may be automated for example by the use of accelerometers, or other sensor(s) for detecting the vertical and off-vertical orientation of the main beam or the horizontal or off-horizontal orientation of the stacked bank of insulators 22, detecting when the main beam 20 or stacked bank of insulators 22 is moved such as by rotation in a vertical plane due to movement of the boom so that, when the main beam is off-vertical, rotation actuator 18 is then automatically actuated accordingly to bring the main beam 20 back to vertical and the stacked bank of insulators 22 back to horizontal. The accelerometers, or other sensor(s) for detecting the vertical and off-vertical orientation of the main beam 20 or the off-horizontal orientation of the stack of insulators 22, provide feedback to a processor which in turn provides actuation instructions resulting in the actuation of the rotation actuator.

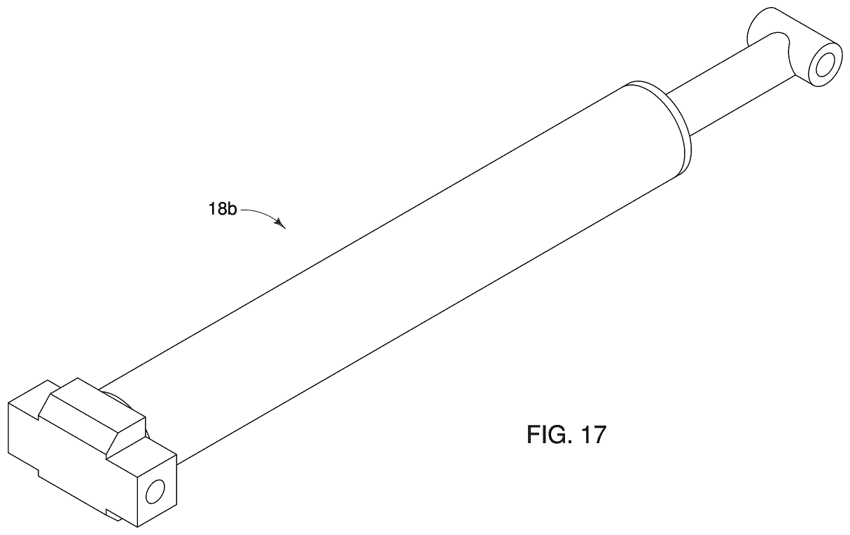

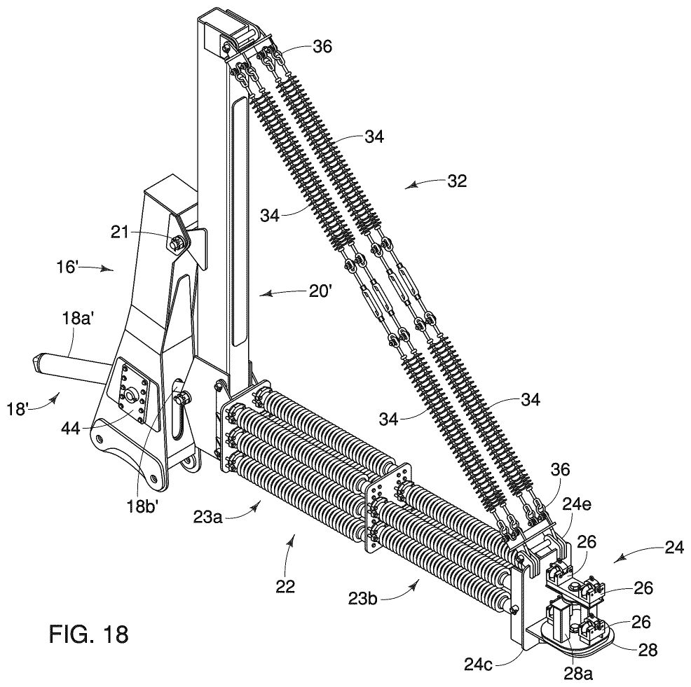

In the alternative embodiment of FIG. 18, instead of using rotation actuator 18 to rotate main beam 20 relative to boom adapter 16 via the scissor linkage coupling, rotation actuator 18′, which includes a hydraulic cylinder having a linear piston and rod, is directly coupled between boom adapter 16′ and main beam 20′. Actuator 18′ includes a trunnion block 40 which forms part of the actuator 18′. Actuator 18′ and trunnion block 40 are pivotally mounted in boom adapter 16′, as better seen in FIGS. 19 and 19A, through slot 42 in boom adapter 16′. Actuator 18′ and trunnion block 40 is inserted into boom adapter 16′ through slot 42 and then rotated to the horizontal so that the ends 40a of the trunnion block protrude through corresponding openings in the side walls of the boom adapter 16′. Ends 40a are secured by plates 44 mounted to the outer side walls 16a′ of the boom adapter 16′. Plates 44 engage the ends 40a of the trunnion block to allow the trunnion block to pivot and holds the ends 40a in the side walls of the boom adapter 16′.

What is claimed is:

1. A horizontal conductor lifter for supporting, lifting, and moving a conductor or sub-conductors in a conductor bundle supported in an overhead position above ground on a tower or other structure, wherein the horizontal conductor lifter is mountable, when in use, to a distal end of a crane or truck boom via a boom adapter mounted on the end of the boom, the horizontal conductor lifter comprising:
a main beam pivotally coupled to the boom adapter;
a rotation actuator mounted to cooperate between the main beam and the boom adapter for selective pivotal movement of the main beam relative to the boom adapter during use of the horizontal conductor lifter when the horizontal conductor lifter is mounted to the boom adapter on the distal end of the crane or truck boom;
an elongate stacked bank of insulators collectively having oppositely disposed first and second ends, wherein the first end is mounted to the main beam and the second end is mounted to a wire holder adapter so that the stacked bank of insulators is level when the main beam is vertical, and wherein the stacked bank of insulators has a length sufficient to space the wire holder adapter away from the main beam by a clearance distance corresponding to the voltage of the phase carried by the conductor or sub-conductors in a conductor bundle;
at least one wire holder mounted to the wire holder adapter and configured to support the conductor or the sub-conductors of the conductor bundle therein during use of the horizontal conductor lifter, wherein, in use, the wire holders are maintained in an operative vertical orientation on the wire holder adapter; and
a load transfer element having opposite upper and lower ends, wherein the upper end of the load transfer element is coupled to an upper end of the main beam and the lower end of the load transfer element is coupled to the wire holder adapter so as to support, in tension, the weight of the conductor or sub-conductors in a conductor bundle when the conductor is, or sub-conductors in a conductor bundle are supported on the wire holder adapter, and so as to transfer the weight into a compressive load on the stacked bank of insulators and to remove a bending moment on the stacked bank of insulators,
wherein, in use, when the conductor is, or the sub-conductors of the conductor bundle are, supported in the at least one wire holder and the crane or truck boom is being articulated so as to include up or down movement while moving the conductor or sub-conductors in the conductor bundle to a temporarily supported position away from the tower or other structure, the bending moment exerted by the weight of the conductor or sub-conductors in a conductor bundle on the wire holder adapter is resisted by the load transfer element and the stacked bank of insulators to thereby resist the bending moment on the wire holder adapter which would cause rotation of the wire holder adapter to thereby maintain the operative vertical orientation of the at least one wire holder during use, and wherein selective actuation of the rotation actuator, during the articulation of the crane or truck boom, maintains the stacked bank of insulators level thereby maintaining the at least one wire holder in the operative vertical orientation during use.

2. The horizontal conductor lifter of claim 1, wherein the load transfer element includes at least one rigid electrically insulating insulator.

3. The horizontal conductor lifter of claim 2, wherein the load transfer element includes a plurality of the rigid electrically insulating insulators arranged in a linear array so as to provide a linear array of insulators.

4. The horizontal conductor lifter of claim 3, wherein the length and resultant electrical resistance of both the stacked bank of insulators and the linear array of insulators form an insulated truss mounted to, so as to extend from, the main beam to thereby provide a safe clearance distance corresponding to the voltage of the phase conductor or carried by the sub-conductors in a conductor bundle when the horizontal conductor lifter is translated laterally, by the articulation of the boom, so as to engage the at least one wire holder with the conductor or sub-conductors in the conductor bundle.

5. The horizontal conductor lifter of claim 1, wherein the wire holder adapter includes a vertical plate and a horizontal plate mounted orthogonally to the vertical plate, and wherein the at least one wire holder is mounted on the horizontal plate.

6. The horizontal conductor lifter of claim 5 further comprising a support frame adapted to support the at least one wire holder, wherein the support frame is mounted on the horizontal plate, and wherein the linear array of insulators is coupled by a coupler to an upper end of the vertical plate.

7. The horizontal conductor lifter of claim 6 wherein a center of mass of the support structure when supporting the at least one wire holder and the conductor or sub-conductors supported in the at least one wire holder is aligned laterally with an apex of the stacked bank of insulators so as to transfer into a compression loading on the apex a moment loading of the center of mass about the coupler coupling the linear array of insulators to the upper end of the vertical plate.

8. The horizontal conductor lifter of claim 1, wherein the stacked bank of insulators includes a first number of insulators in a base bank of the stacked bank of insulators and a second number of insulators in a distal bank of the stacked bank of insulators, and wherein the first number of insulators is greater than the second number of insulators.

9. The horizontal conductor lifter of claim 6, wherein the base bank and the distal bank form a pyramid of insulators.

10. The horizontal conductor lifter of claim 7, wherein the insulators in the base bank and distal bank are each 230 kV insulators.

11. The horizontal conductor lifter of claim 8, wherein the insulators in the linear array of rigid electrical insulators are 230 kV dead end insulators.

12. The horizontal conductor lifter of claim 7, wherein the insulators in the base bank and distal bank are each 80-inch, long insulators.

13. The horizontal conductor lifter of claim 3, wherein the load transfer element includes at least first and second insulators coupled end-to-end to each other so as to form the linear array of insulators.

14. The horizontal conductor lifter of claim 11, wherein the linear array of insulators includes at least a parallel pair of linear arrays of insulators.

15. The horizontal conductor lifter of claim 1, wherein the rotation actuator includes a scissor linkage assembly and a hydraulic cylinder.

16. The horizontal conductor lifter of claim 1, wherein the rotation actuator includes a linear piston and rod assembly.

17. A method of using the horizontal conductor lifter of claim 1, the method comprising:
manipulating the crane or truck boom to position the horizontal conductor lifter in the horizontal orientation adjacent the conductor bundle supported on the tower or other structure in an original position;
locating sub-conductors of the conductor bundle into their corresponding wire holders on the horizontal conductor lifter so as to temporarily couple the sub-conductors of the conductor bundle with their corresponding wire holders;
transferring the loading, due to the sub-conductors in the wire holders, to the main beam through at least the load transfer element and the stacked insulators; and
moving the conductor bundle temporarily coupled onto the horizontal conductor lifter away from the tower or other structure to a temporary position, spaced away from the original position, while actuating the rotation actuator so as to maintain the vertical orientation of the wire holders and the horizontal orientation of the conductor lifter during the moving of the conductor bundle to the temporary position.

18. The method of claim 17 wherein the rotation actuator is automatically actuated to maintain the main beam vertical during moving the sub-conductor bundle.
